(19) United States
(12) Patent Application Publication
(10) Pub. No.: US 2018/0062215 A1
(43) Pub. Date: Mar. 1, 2018

(54) BATTERY SYSTEM AND METHOD FOR OPERATING A BATTERY SYSTEM

(71) Applicant: Robert Bosch GmbH, Stuttgart (DE)

(72) Inventors: Andre Boehm, Marbach am Neckar (DE); Thomas Dufaux, Stuttgart (DE); Michael Erden, Remseck (DE); Ulrich Lange, Aichtal (DE)

(21) Appl. No.: 15/559,864

(22) PCT Filed: Jan. 21, 2016
(86) PCT No.: PCT/EP2016/051216

§ 371 Date: Sep. 20, 2017

(30) Foreign Application Priority Data
Mar. 24, 2015 (DE) 10 2015 205 252.4

(51) Int. Cl. H01M 10/42

(52) U.S. Cl. CPC H01M 10/4257; H01M 2220/20; H01M 10/42

(57) ABSTRACT

The present invention relates to a method for operating a battery system, wherein the battery system comprises a battery which is operable using an operating parameter, wherein the method has the following method steps: a) defined operating of the battery using a predefined variable of the operating parameter in such a way that b) at least one of the duration of the operation of the battery using the predefined variable of the operating parameter and the variable of the operating parameter is selected based on a load criterion, wherein c) the load criterion is determined for maintaining a future predetermined aging progression of the battery, wherein the aging progression is based on a load of the battery by the operating parameter. A previously described method enables the operation of a battery with a particularly high performance, for example, with a particularly high capacity, in a simultaneously safe operating mode.

### BACKGROUND OF THE INVENTION

The present invention relates to a battery system and a method for operating a battery system that allow an improved capacity with a simultaneously high level of safety for the battery.

It is barely possible to imagine life today without a wide variety of batteries, such as lithium-based energy stores or lithium ion batteries, for example. Areas of application include not only fully electrically driven vehicles or hybrid vehicles but also electric tools, consumer electronics, computers, mobile phones and further applications.

In this case, a wide variety of batteries often have provision for said batteries to have limit values for various parameters in order to operate the batteries in a safe state. It is therefore known practice to monitor and control a battery system such that operation of the battery system in the safe operating state can be ensured.

By way of example, the document JP 2014-011826 A discloses a method for monitoring a charging process of a battery. It states that a terminated charging process of the battery is detected by a limit value for a charging current. In this case, the ageing state of the battery is detected in order to adapt the limit value of the charging current in accordance with the ageing state.

The document EP 0 508 720 A1 further discloses a control loop for controlling the charging process of a battery. The input variable used for the control loop is the internal resistance of the battery, which is compared with a reference value in order to ascertain the state of charge.

The document EP 2 680 392 A1 describes a method for recharging a battery. The aim in this case is for the capacity of the battery to be increased without exceeding a charging threshold. This is intended to be achieved, in line with this document, by virtue of the battery being charged repeatedly during a charging cycle.

The document US 2011/0057623 A1 further discloses a battery system in which the battery is monitored and applicable information is transmitted to a charger in order to allow energy saving and further to increase efficiency and functionality.

### SUMMARY OF THE INVENTION

The subject of the present invention is a method for operating a battery system, wherein the battery system comprises a battery that is operable with an operating parameter, wherein the method has the method steps of:

a) Defined operation of the battery with a predefined magnitude of the operating parameter such that

b) at least one from the period of operation of the battery with the predefined magnitude of the operating parameter and the magnitude of the operating parameter is selected on the basis of a loading criterion, wherein

c) the loading criterion is ascertained for the purpose of observing a future predetermined ageing profile of the battery, the ageing profile being based on a loading of the battery by the operating parameter.

A method as described above allows the operation of a battery with a particularly high level of performance, for example with a particularly high capacity, given a simultaneously safe mode of operation.

The method relates to operation of a battery system, wherein the battery system comprises a battery that is operable with an operating parameter.

The text below describes the operation of the battery with reference to an operating parameter, the operation of the battery or the performance of the method with reference to a plurality of at least two operating parameters being covered by the invention in equal measure in a way that is comprehensible to a person skilled in the art.

In addition, the invention is described below with reference to a battery, a battery comprising a battery cell, or a plurality of battery cells, for example combined to form a battery module or battery pack, of the invention in equal measure in a way that is comprehensible to a person skilled in the art.

The method is based on batteries being operated in a conventional manner with reference to an operating parameter, such as with reference to the voltage provided by the battery, to the current flowing through the battery and to the temperature of the battery, for example, at values that are within prescribed operating limits. Conventionally, a battery comprises rigid operating limits in this context. These operating limits comprise particularly a safety threshold from which, depending on the magnitude and duration of the value of the respective operating parameter, safety measures should be taken, since there may be a safety reduction if the safety threshold is exceeded and hence if the battery is operated in the critical operating state.

In addition, there may be provision for a normal operating threshold that is arranged at a distance from the safety threshold, the range below the normal operating threshold being the normal operating range, the range between the normal operating threshold and the safety threshold being the safety operating range and the range above the safety threshold being the critical operating state. In this case, the normal operating threshold can determine the magnitude of the value of the operating parameter within which the battery can fundamentally be operated particularly advantageously with reference to the operating parameter in a conventional manner, and may be stipulated as a preferred operating limit by the manufacturer of the battery, for example. Within the normal operating threshold, the battery can firstly be operated without safety reservations, since this operating threshold is at a distance from the safety threshold, and in this case below it, for example, with reference to the magnitude of the value of the operating parameter. Besides a particularly high level of safety as a result of the provision of a safety buffer by the safety operating range, provision of the normal operating threshold can solve the problem of operation of the battery within the framework of the normal operating threshold or in the normal operating range also permanently being able to allow the loading of the battery during operation to be limited to a prescribable value. As such, the life of the battery can satisfy a predetermined optimum condition, for example, since the normal operating threshold can allow operation of the battery in a particularly gentle state.

The provision of the normal operating threshold or the provision of a distance between the normal operating threshold and the safety threshold can further have the further advantage that undesirable initiation of safety measures can be prevented in the event of the normal operating threshold being exceeded only for a short time. In such a case, further operation without a safety risk may usually be possible, which means that safety measures are not required. Hence, the defined provision of the normal operating threshold and the safety threshold can fundamentally allow particularly gentle and reliable operation of the battery or of the battery system.

The method described above for operating the battery system now exploits the fact that the normal operating threshold, for example stipulated by a battery manufacturer, and hence limitation of the voltage, for example, is valid for a wide variety of modes of operation in order to be able to use the battery in as many different applications as possible. However, this means that there may be provision for a comparatively large safety operating range to be provided in order to be able to ensure safety for all operating conditions and areas of application if need be. Hence, it has been found that, between the normal operating threshold and the safety threshold, that is to say in the safety operating range, it is possible to allow operation of the battery that admittedly may involve there being slight impairments with reference to the loading of the battery, but that still ensures safe operation without any problems. Hence, in comparison with a battery management system without the described methodology or without the use of the method described above, a higher voltage range becomes usable and hence more energy from the cell becomes available.

In detail, the method comprises the method steps of:

a) Defined operation of the battery with a predefined magnitude of the operating parameter such that

b) at least one from the period of operation of the battery with the predefined magnitude of the operating parameter and the magnitude of the operating parameter is selected on the basis of a loading criterion, wherein

c) the loading criterion is ascertained for the purpose of observing a future predetermined ageing profile of the battery, the ageing profile being based on a loading of the battery by the operating parameter.

The method is therefore based on the fact that, particularly when the safety threshold is not exceeded, there are no safety reductions, but rather it is merely possible for the loading of the battery to be increased in a controlled manner. This particularly increases the impairment of the battery, which can often be accepted, however. In particular, impairment of the battery can comprise future ageing, which means that the operating parameter or the magnitude thereof and the period of use of the magnitude of the operating parameter is selected based on future ageing of the battery or a loading criterion linked thereto.

Hence, the method can be designed, or the battery system can be configured, such that defined demands on the life of the battery and hence on a future ageing profile can be met when the limits with reference to the period and level of use of the parameter are observed.

Ageing of the battery, for example as a result of an increased battery voltage, can be brought about in this case, by way of example, by the occurrence of secondary reactions, which can consume active material, in particular irreversibly. In the nonrestrictive case of a lithium battery, for example, lithium or a lithium species can be consumed.

In order to describe ageing of the battery and hence a loss of charge carrier capacity or charge carrier ability, it is possible to use a loading criterion. The loading criterion may in this case be based particularly on a loading of the battery by the operating parameter that is used and regulated in accordance with the invention. Hence, the method comprises not adjustment of the parameter on the basis of a value predetermined during manufacture or startup, for example, but rather on the basis of a specifically ascertained loading criterion that is ascertained repeatedly during the operating time of the battery, so as to take into consideration the specifically obtaining properties of the battery.

This loading criterion may be stored or applied in the software of a control unit of the battery system, such as in the battery management system, for example, and be used, by way of example, to describe the ageing brought about by increasing the loading or by increasing the performance of the battery and, by regulating the operating parameter, likewise to regulate the ageing or to keep it within defined limits.

An exemplary loading criterion S as a function in amp-hours [Ah] can be used to describe the ageing both at very high and at low voltages and hence substantially over the entire voltage range of the battery, at which voltages there is a significant occurrence of secondary reactions. The loading criterion S may be as follows, for example:

S=∫|I_{SR}|dt

Here, S describes the loading criterion that corresponds the loss of capacity from the battery as a result of secondary reactions occurring. The loading criterion S can be described, by way of example, as a current including the sum of all secondary reactions I_{Sr} or the loss of capacity associated therewith on the basis of time. In other words, the loss of capacity can be obtained as a time integral using the absolute value of the function I_{SR} or of the secondary reactions, which occur particularly in ranges of very high or low voltage and consume active material, such as lithium, for example.

By way of example, the sum of all secondary reactions I_{Sr} may be ascertainable in this case as follows:

I_{SR}=Iₜ·e^{k}^{ₜ}^{(U-U}^{ₜ}⁾+I·F_{I}·e^{k}^{ₜ}^{(U-U}^{ₜ}⁾

Here, the value I_{SR} is made up of the sum of all secondary reactions for a switched-off battery or while the battery is at rest It·e^{k}^{ₜ}^{(U-U}^{ₜ}⁾ and of the sum of all the secondary reactions for a switched-on battery, which is therefore charged or discharged I·Fₜ·e^{k}^{_{T}}^{(U-U}^{_{I}}⁾. For the nonrestrictive case of performance of the method in an electrically driven vehicle, the first factor can therefore describe the secondary reactions during parking of the vehicle, whereas the second factor can describe, by way of example, the secondary reactions during driving of the vehicle and hence charging and discharging of the battery.

The secondary reactions have an exponential dependency of the voltage. In the case of the first factor of the equation described above, Iₜ corresponds to the quiescent current that is initiated by the secondary reaction and that models the secondary reactions when the battery is not operated and ages calendrically, kt corresponds to the temperature dependency of the secondary reactions for a switched-off battery, U corresponds to the present battery voltage and Uₜ corresponds to a threshold value of the voltage from which there is significant occurrence of the secondary reactions under consideration. In particular, the assumption is made that the secondary reactions examined do not occur in a mean voltage range, for example, but rather obtain only when a limit voltage Uₜ is exceeded. In the case of the second factor of the above equation, I corresponds to the impressed current, F_{I} corresponds to a proportionality factor that can change over the life, for example, k_{I} describes the temperature dependency of the secondary reaction for a switched-on battery, U is the currently applied battery voltage and U_{I} is the voltage threshold of the secondary reaction. Hence, the secondary reaction is proportional by F_{I} to the impressed current I, F_{I} being able to change over the life, for example.

The voltage used can be the terminal voltage of the battery during operation. However, it may be substantially more accurate if, by way of example, a control unit, such as the battery management system, can estimate or measure the electrode voltages of the anode and the cathode, for example against Li⁺ in the case of exemplary use of a lithium battery, and the result is used as a basis for the voltage U.

In this case, the parameters that are not immediately measurable, such as the temperature dependencies kₜ, k_{I}, the voltage limits U_{I}, Uₜ or the proportionality factor F_{I}, for example, can be ascertained by applicable measurements. This may, by way of example, be implementable by means of cyclization trials for the battery, which involve losses of capacity at different voltages being ascertained, for example.

Hence, Kₜ, Uₜ and Iₜ describe the quiescent state of the battery, whereas K_{I}, U_{I} and F_{I} describe the operation of the battery.

The value I_{SR} determinable from the predetermined parameters is, as already described, the sum of all secondary reactions and is integrated as an absolute value over the driving cycle; it corresponds to the loss of capacity as a result of the secondary reactions.

From the above, it is evident that the loadings that may occur and the accompanying intensified ageing profile can be controlled or determined in accordance with the invention by virtue of b) at least one from the period of operation of the battery with the predefined magnitude of the operating parameter and the magnitude of the operating parameter being selected on the basis of a loading criterion, wherein, in accordance with method step c), the loading criterion is ascertained for the purpose of observing a future predetermined ageing profile of the battery, the ageing profile being based on a loading of the battery by the operating parameter. In other words, a method as described above has provision for merely one safety threshold to be firmly provided, but for there to be, at least temporarily, no constant normal operating threshold used, but rather for the adjustment of the parameters to be regulated dynamically on the basis of a predetermined and desired future ageing. This allows ageing targets to be achieved without any problems. In the event of there further being a constant normal operating range, this can be left in a predefined and desired manner with reference to the operating parameters, with preferably the magnitude of the parameter in the safety operating range and the period in which the parameter is in the safety operating range or at a respective magnitude being controlled in a predefined manner.

In this way, it is particularly possible for the ageing to be in an acceptable or feasible range, and further for it to be predictable.

In the case of the method described above, it is therefore possible for the usable operating range of the operating parameter to be increased at least to a limited extent in a defined and controlled manner without having to be afraid of unpredictable and unwanted influences on the battery and accompanying disadvantages.

In contrast to the methods from the prior art, where a predetermined constant normal operating threshold should always not be exceeded, the method described above takes an opposite path and uses the safety operating range on the other side of an imaginary constant normal operating threshold, in order to increase the performance of the battery in a defined manner. Hence, the operating parameter is adjusted selectively such that its magnitude can also enter an original safety operating range so as to be able to adapt the performance in a desired manner. In this case, it is a credit to the inventors to have found that the performance of the battery can be raised significantly in this way without safety reservations and with calculable and predeterminable impairments.

The method described above therefore exploits the fact that exceedance of the normal operating threshold or the removal of a constant normal operating threshold allows the performance of the battery to be distinctly raised in comparison with permanent operation within the originally prescribed normal operating threshold, but without having to accept a loss of safety or significant limitations.

This requires no complex implementation of the method in existing operating systems, but rather the previously described operation of the battery system can take place, by way of example, in a simple manner by virtue of the battery management system. In this case, the method may further be based on parameters that are often ascertained anyway, which means that essentially no further sensors or the like need to be used.

Hence, the method described above can allow the performance of the battery, such as the capacity of the battery, for example, to be increased in a simple and safe manner.

In one configuration, there may be provision for the operating parameter to be selected from the group consisting of voltage, current and temperature. Particularly the aforementioned operating parameters, that is to say the voltage provided by the battery, the current flowing through the battery and a temperature of the battery, can allow an applicable increase in this operating parameter to make it possible for the performance of the battery to be raised significantly. This becomes apparent from use of the voltage of the battery as an operating parameter, for example. Just a comparatively small rise in the voltage of, by way of example, 0.25 V, for example from 4.15 V to 4.40 V, can allow a 15% rise in capacity, the aforementioned values being merely by way of example. In this case, there may also be provision within the context of this configuration for only one of the aforementioned operating parameters to be used, or for a plurality of at least two of the aforementioned operating parameters to be used or for the battery system to be operated in the respective safety operating range intentionally and in a defined manner with reference to said operating parameters.

In a further configuration, there may be provision for the method to be effected during a charging process of the battery. In other words, in this refinement, it is possible, by way of example, for the voltage to be increased in a defined manner, so that, for example, the charging threshold or state of charge threshold can be increased in a defined manner on the basis of a desired future ageing profile. This configuration may be advantageous particularly because a charging process, when the state of charge is rising, can involve a comparatively large increase in the capacity of the battery being made possible with just a comparatively small increase in the state of charge or in the voltage of the battery. Hence, particularly when the method is effected at least partly, in particular completely, during a charging process, it is possible for a significant rise in the capacity and hence in the performance of the battery to be produced.

It may further be preferred if the loading criterion is ascertained during operation of the battery. In this case, determination of the loading criterion during the operation of the battery can mean that the loading criterion is determined during charging or discharging of the battery. In this configuration, the loading criterion can be ascertained online, that is to say immediately during operation. As a result, it can always be based on up to date values, which can allow the loading criterion to be ascertained particularly exactly. As a result, it is additionally possible for the observance of a desired ageing profile, by way of example, to be made possible particularly safely and exactly. In this configuration, the ascertainable variables, such as current or voltage, for example, are therefore ascertained immediately during operation of the battery.

It may additionally be preferred if the loading criterion is ascertained on the basis of a stored history of the operating parameter, particularly in a quiescent phase of the battery. In this configuration, only the applicable operating parameter or the applicable operating parameters, such as current and/or voltage, for example, can be recorded during operation of the battery. As a result of ascertainment being able to be effected during a quiescent phase of the battery, that is to say when no charging or discharge processes are taking place, for example during parking of a vehicle, it is possible for the computation power of the battery management system to be chosen to be particularly low during operation of the battery. This means that no increased demands on the equipment of the battery system or on configuration of the battery management system need to be observed. An implementation in existing systems is thus possible by virtue of simple software adaptation without further conversion measures.

Furthermore, the loading criterion can be ascertained by exclusively considering values that are above a predefined threshold. This threshold may be, by way of example, the limit value U_{I} or Uₜ from which there is a significant start to a secondary reaction. Fundamentally, the threshold can be chosen such that a raised ageing profile occurs only from this threshold onward. Such a value may be, by way of example, 4.1 to 4.2 V. Up to this threshold, the battery can be operated without any problems and still meet its ageing targets. Hence, consideration of only the values above the threshold may be sufficient, since the applicable values below the threshold are of only subordinate relevance for ascertaining ageing and hence the inclusion of said values does not or does not significantly influence the result. Concentration on the aforementioned relevant values can save computation capacity, for example in the battery management system, to a great extent, however, which means that it may also be possible for the loading criterion to be ascertained without any problems online, that is to say during operation of the battery.

In relation to determination of the predetermined ageing profile on the basis of a loading criterion that is ascertained on the basis of a stored history of the operating parameter, these operating parameters can be stored in a two-dimensional histogram, for example. This may be advantageous particularly when, as explained above, two, for example related, operating parameters, such as current and voltage, for example, are stored in equal measure. In the case of a two-dimensional histogram that plots current against voltage, it is possible for ascertainment of the loading criterion to be performed as follows, for example:

$$\int \vert {I}_{SR} \vert dt \approx {\sum }_{U} {\sum }_{I} N \cdot dt \cdot \vert {I}_{Bins} \vert$$

Here, ∫|I_{SR}|dt again corresponds to the loading criterion as already explained above,

$${\sum }_{U} {\sum }_{I} N \cdot dt$$

corresponds to the sum of all ascertained measured variables for the respective operating variable, that is to say in this case current and voltage over time, where N corresponds to the number of ascertained values, and |I_{Bins}| corresponds to the resolution of the ascertained measurement points, that is to say for current and voltage, for example, in the histogram. By referring to the time integral and the sum of the measurement points in the histogram, the form of the loading criterion is as follows:

$$S \approx {\sum }_{t} dt \cdot {I}_{t} + {e}^{( U - {U}_{t} )} + {\sum }_{U} {\sum }_{I} N \cdot dt \cdot {F}_{I} \cdot \vert {I}_{Bins} \vert \cdot {e}^{( U - {U}_{I} )}$$

The aforementioned preferred examples relate particularly to the ascertainment of the loading criterion and hence, for example, of the ageing profile on the basis of voltage as operating parameter.

Further possibilities for ascertaining the loading criterion or further suitable operating parameters comprise, for example, temperature, current intensity or abrupt changes or swings in the state of charge (SOC swings) during operation of the battery, such as during a driving cycle of an electrically driven vehicle, for example. Such parameters can also adversely influence the electrode material, for example by virtue of phase transitions.

By way of example, an increased current intensity results in an increased temperature, and SOC swings result in swelling and deswelling of the electrodes and hence in material attrition.

An exemplary loading criterion for temperature could be ascertained as follows in accordance with the aforementioned conditions and assumptions:

I_{SR}=I_{T}·e^{k}^{_{T}}^{(T-T}^{ₜ}⁾

Here, I_{T} is again the no-load current, kₜ is the temperature dependency of the secondary reaction or of the ageing effects and Tₜ is the threshold value of the temperature from which the secondary reactions or the ageing effects occur.

It is also possible for combinations of loading criteria of different operating parameters to be ascertained in a manner comprehensible to a person skilled in the art.

The method described above can comprise a large portion of the factors that cause ageing of the battery. The quality of the feedback control still allows reliable operation of the battery to be made possible, however, even if the disregarded parameters, such as calendric ageing or other ignored factors, for example, account for a range of up to 70% of total ageing.

It may additionally be advantageous for the predefined magnitude of the operating parameter to be selected on the basis of a control period. By way of example, the magnitude can be selected for short-term control, which, by way of example, is valid for a few charging cycles, such as five charging cycles, for example, and further for long-term control, which is valid for more than ten charging cycles, for example. In this configuration, it is therefore firstly possible to allow long-term control, which regulates continuous operation of the battery, and further short-term control, which allows the performance to be increased to an even greater extent for a short time. By way of example, the long-term control can comprise a charge throughput of 5000 Ah, for example, and be valid in the region of a few months, for example. In addition, short-term control can be valid for an exemplary charge throughput of 100 Ah or one or fewer weeks, for example.

In respect of further technical features and advantages of the method, explicit reference is made hereby to the explanations relating to the battery system, to the figures and to the description of the figures, and vice versa.

The subject of the present invention is further a battery system having at least one battery and a feedback control unit for regulating the battery. The battery system is characterized in that the feedback control unit is designed to carry out a method as described in detail above.

In detail, the battery system can have a battery or a plurality of batteries, such as a plurality of battery cells, for example. The batteries or battery cells may be connected to a battery module, for example, in order to be able to allow the desired specification. Purely by way of example and without implying any kind of limitation, the battery or batteries may be lithium batteries, such as lithium ion batteries, for example. Further, there may be provision for the battery system to be arranged in an at least partly electrically driven vehicle.

The battery system has not only the battery but also a feedback control unit that can regulate the operation of the battery and that therefore has at least one control loop. To this end, applicable sensors may be provided, for example in order to detect the temperature of the battery, the voltage provided by the battery or the current flowing through the battery. Further, a computation unit may be provided that uses the detected operating parameters to ascertain whether control intervention is necessary or how the operating parameters should be adjusted in order to implement a desired specification, such as a desired ageing profile, for example.

As a particular preference, there may be provision for the feedback control unit to have at least one first control loop and a second control loop, which is interleaved with the first control loop. In this configuration, particularly effective regulation of the battery can be effected, particularly with reference to a method as described in detail above.

In this case, it may be particularly preferred if the first control loop is designed to output at least one controlled variable for the purpose of achieving a prescribed ageing profile and the second control loop is designed to output at least one controlled variable for the purpose of achieving a prescribed loading criterion. To implement this, it may be preferred for a setpoint value of the first control loop to be selectable and/or for a setpoint value of the second control loop to be based on a controlled variable output by the first control loop.

A feedback control structure as described above can allow regulation of the battery in a particularly effective and safe manner, allowing the battery to be regulated with reference to a maximum load, for example by virtue of safely determinable and implementable controlled variables. In this case, regulation with reference to a load can be interleaved with regulation with reference to a desired ageing profile.

In detail, particularly the provision of two interleaved control loops, as is explained above, can allow input of a desired ageing profile into the first control loop to prompt the latter to output a controlled variable that serves as an input for the second control loop. On the basis of this input, the second control loop can regulate the battery to a desired load particularly when the controlled variable, inter alia, of the first control loop can be taken as a basis for ascertaining a load criterion. Hence, the control unit can operate the battery at a defined load, in order to be able to observe the desired ageing, by simply inputting a setpoint ageing.

### BRIEF DESCRIPTION OF THE DRAWINGS

In respect of further technical features and advantages of the battery system, explicit reference is hereby made to the explanations relating to the method, to the figures and to the description of the figures, and vice versa.

Further advantages and advantageous configurations of the subjects in accordance with the invention are illustrated by the drawings and explained in the description below, the features described being able to be a subject of the present invention individually or in any desired combination, unless the context explicitly reveals otherwise. In this case, it should be noted that the drawings are only descriptive in nature and are not intended to limit the invention in any form. In the drawings,

FIG. 1 shows a schematic view of various operating states of a battery;

FIG. 2 shows a schematic view of a voltage profile for a battery over time;

FIG. 3 shows a schematic view of a further voltage profile for a battery over time;

FIG. 4 shows a schematic view of a further voltage profile for a battery over time;

FIG. 5 shows a graph showing regulation of a battery by way of example;

FIG. 6 shows a schematic view of a feedback control structure;

FIG. 7 shows an example of the ascertainment of a loading criterion on the basis of a histogram; and

FIG. 8 shows a schematic example of the regulation of a battery over a multiplicity of charging cycles.

### DETAILED DESCRIPTION

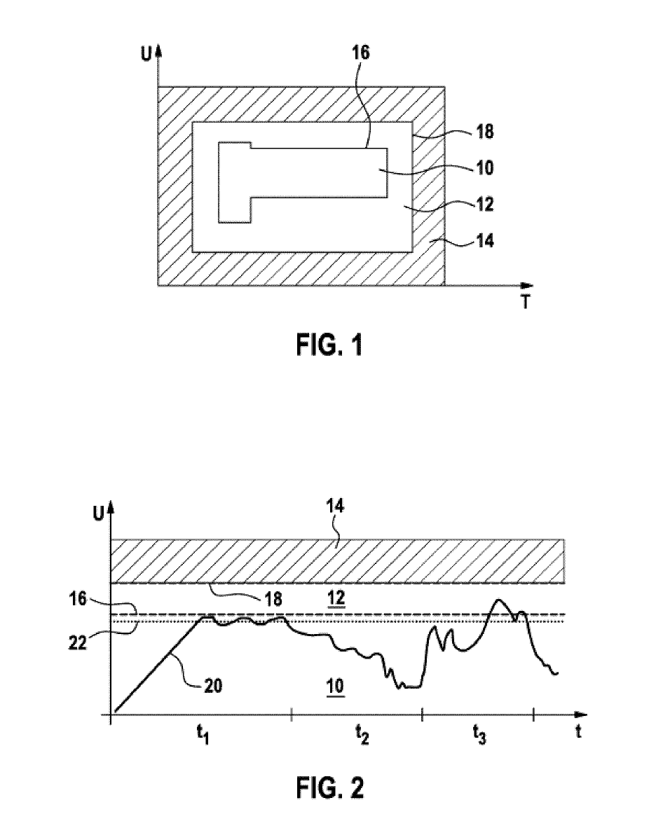

FIG. 1 shows, with reference to the temperature and the voltage of a battery, schematically and purely by way of example, various operating states within which the battery may be intentionally or unintentionally in operation. In detail, the temperature T is shown on the X axis against the battery voltage U on the Y axis. In this case, the operating states comprise a normal operating range 10, a safety operating range 12 and a critical operating range 14. The figure further shows that a normal operating threshold 16 separates the normal operating range 10 and the safety operating range 12 and that a safety threshold 18 separates the safety operating range 12 and the critical operating range 14.

The normal operating range 10 is in this case an operating range of this kind in which the battery is operated such that there is both a particularly high level of safety and the possibility of further predetermined demands being observed, such as cell capacity, energy content, charging/discharging force and life or end of life criteria (EOL criteria), for example. A normal operating range 10 of this kind can be defined or limited by an operating threshold by the manufacturer of the battery or of the battery system, for example.

The critical operating range 14 is additionally one in which safety-decreasing effects can be expected. Hence, a critical operating range may particularly have provision for countermeasures to be taken, that is to say for at least one measure to be initiated in order to counteract a fault situation arising.

The safety operating range 12 is further one in which, additionally, safe operation of the battery is ensured such that no serious fault situations and no irreversible damage to the battery must be feared that entail a repair. Certain demands, such as on capacity, life or the like, for example, can be altered or influenced in this operating range, however. In this case, it is preferred if there is provision for a sufficient distance between the normal operating threshold 16 and the safety threshold 18. In this way, it is possible to accept slight exceedance of the normal operating threshold 16 without countermeasures immediately needing to be initiated, which may not necessarily be needed during desired operation. This can occur for a short time during operation of the battery, for example unintentionally, or this can take place intentionally for a predetermined period and to a predetermined extent, as described below.

FIG. 2 schematically shows the time t on the x axis and the voltage U on the y axis. Further, the curve 20 shows the voltage applied for the battery. In addition, a prescribed charging limit 22 is shown, as is the normal operating threshold 16, which limits the normal operating range 10 and may be above the charging limit 22, for example slightly, for example in a region of 5 mV, and the safety threshold 18, from which there may be the critical operating range 14, for example, and below which there may be the safety operating range 12, for example.

Further, the ranges t₁ can denote a charging process, t₂ can denote a discharge process, for example during operation of an electrically driven vehicle, and t₃ can denote a recuperative process. It can be seen that it is often not possible to prevent the voltage, for example during charging or recuperation, from unintentionally rising above the charging limit 22 or above the normal operating limit 16. This can be accepted, however, since the normal operating threshold 16 is at a sufficiently great distance from the safety threshold 18, which means that the voltage is always in the safety operating range 12.

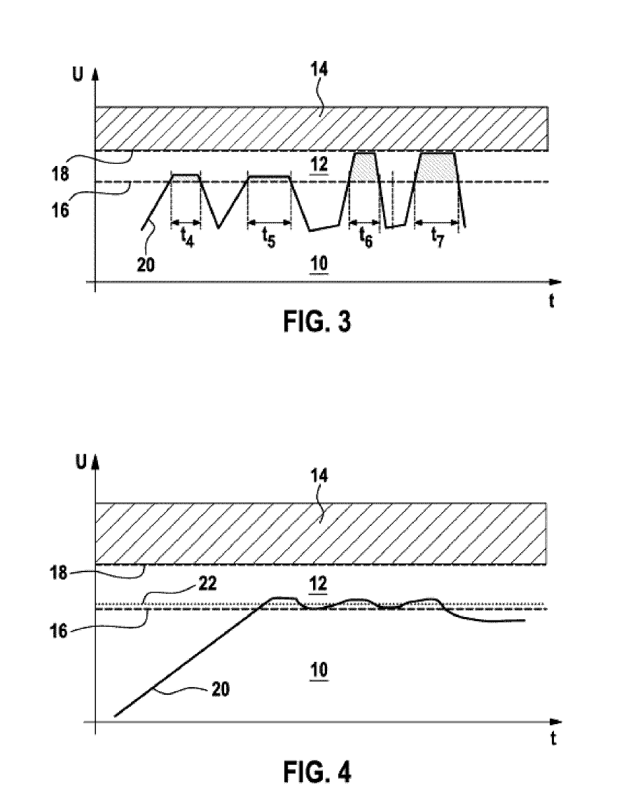

In this case, an estimate of the extent to which the battery is being operated in the safety operating range 12 and this can be accepted can comprise particularly an assessment of the level of the operating parameter, such as the voltage, for example, and the corresponding length of time for operation in the safety operating range 12. This is shown in FIG. 3.

In detail, FIG. 3, like FIG. 2, shows the time t on the x axis and the voltage U on the y axis. Further, the curve 20 again shows the voltage applied for the battery. In addition, a prescribed charging limit 22, which in this configuration corresponds to the normal operating threshold 16 that limits the normal operating range 10, and the safety threshold 18, from which there may be the critical operating range 14, for example, and below which there may be the safety operating range 12, for example, are shown.

The time ranges t₄ and t₅ show a comparatively short length of time for the exceedance of the normal operating threshold 16, for example in the length of time of 300 ms (t₄) and 500 ms (t₅). In addition, with reference to the lengths of time, the periods t₆ correspond to the period t₄ and the period t₇ corresponds to the period t₅. With reference to the magnitude of the voltage in the period of operation of the battery in the safety operating range 12, it can be seen that there is a much higher voltage during the periods t₆ and t₇ than during t₃ and t₄.

In this case, mere consideration of the length of time for operation of the battery in a safety operating range 12 and mere consideration of the level of the operating parameter during operation of the battery in the safety operating range 12 may be sufficient. Sometimes, however, this can lead to results with a comparatively low quality, since, when concentrating on time, the lengths of time t₅ and t₇, for example, would be regarded as critical, whereas when purely considering the level, the periods t₆ and t₇ would be regarded as critical.

When considering both the lengths of time and the level of the respective operating parameter, which corresponds to taking the area beneath the curve 20 above the normal operating threshold 16, that is to say the shaded area in FIG. 3, as a basis, for example, this can lead to an altered and possibly improved result. Mathematically, this can be described as follows:

Xₑᵣᵣ=∫(Uₘₑₐₛ−Uₗᵢₘᵢₜ)dt,

where Xₑᵣᵣ is an error integral and Uₘₑₐₛ is the measured or presented voltage and Uₗᵢₘᵢₜ is the voltage threshold in line with the normal operating threshold 16. For the applicable periods and voltages, this can lead, purely by way of example, to the following values: Xₑᵣᵣ for t₄ is 3 mVs, Xₑᵣᵣ for t₅ is 5 mVs, Xₑᵣᵣ for t₆ is 15 mVs and Xₑᵣᵣ for t₇ is 25 mVs. On the basis of these data, an accurate and reliable assessment of the negative influencing of the battery, for example, can be made possible.

Alternatively, square weighting can take place:

Xₑᵣᵣ=∫(Uₘₑₐₛ−Uₗᵢₘᵢₜ)²dt

For the applicable periods and voltages, this can lead, purely by way of example and in comparison with the assumption described above, to values as follows:

Xₑᵣᵣ for t₄ is 300 μV²s, Xₑᵣᵣ for t₅ is 50 μV²s, Xₑᵣᵣ for t₆ is 750 μV²s and Xₑᵣᵣ for t₇ is 1250 μV²s. On the basis of these data, it is possible to allow an even more exact and hence even more reliable appraisal of the negative influencing of the battery, for example. The square weighting of the voltages has the advantage that particularly defined operation of the battery can be made possible.

It is thus evident that, with reference to one or more operating parameters, defined operation of the battery in the safety operating range 12 or with the relevant magnitude can advantageously be made possible by an assessment both of the period of operation of the battery in the safety operating range 12 or with a defined magnitude and the magnitude of the operating parameter during operation of the battery in the safety operating range 12 or with the relevant magnitude.

Returning to FIG. 1, with reference to the position of the operating range thresholds 16, 18, it is possible to resort to a classification of the EUCAR, for example, which is a classification into various threat levels for particular fault situations with reference to electrical systems (EEES, electrical equipment safety system). In accordance with this grading, various effects are attributed to various fault situations. These can range, by way of example, from the lowest threat level, at which no negative effect can be expected, through to a highest threat level, at which an explosion in the battery must be expected, for example. The normal operating threshold 16 with reference to the respective operating parameter(s) may in this case be arranged below threat level 0 according to EUCAR, and the safety threshold 18 may further correspond to the limit for threat level 0 according to EUCAR, for example. These thresholds are often stipulated by the manufacturer and are stored in a control unit or feedback control unit, such as in the battery management system, for example. These thresholds are normally universally valid and hence prescribed for all driving states and applications in equal measure in order to allow operation of the battery safely and in a manner balanced in universally valid fashion for all operating states.

In accordance with the invention, there is now provision for operation of the battery no longer to be fundamentally designed for all operating states and applications in advance, but rather for the loading of the battery to be selectively controlled and thus for the performance of the battery to be improved.

FIG. 4 shows the method in accordance with the invention schematically. Particularly in comparison with FIG. 2, it can be seen that the desired charging voltage threshold 22 has been shifted to the safety operating range 12 in a defined manner. In this case, a person skilled in the art can see that there may still be a normal operating threshold 16 but that there no longer necessarily has to be one, that is to say that said threshold can subsequently be regarded as an imaginary threshold. As a result, by virtue of an increased voltage being reached despite safe operation of the battery, it is possible for an increased capacity to be attained by virtue of the voltage being in the safety operating range in a defined manner, particularly as a result of long-term control, and not primarily, as is shown in FIG. 2, in the normal operating range 10. This may be advantageous particularly because a comparatively large improvement in the capacity is possible given comparatively small increases in the voltage.

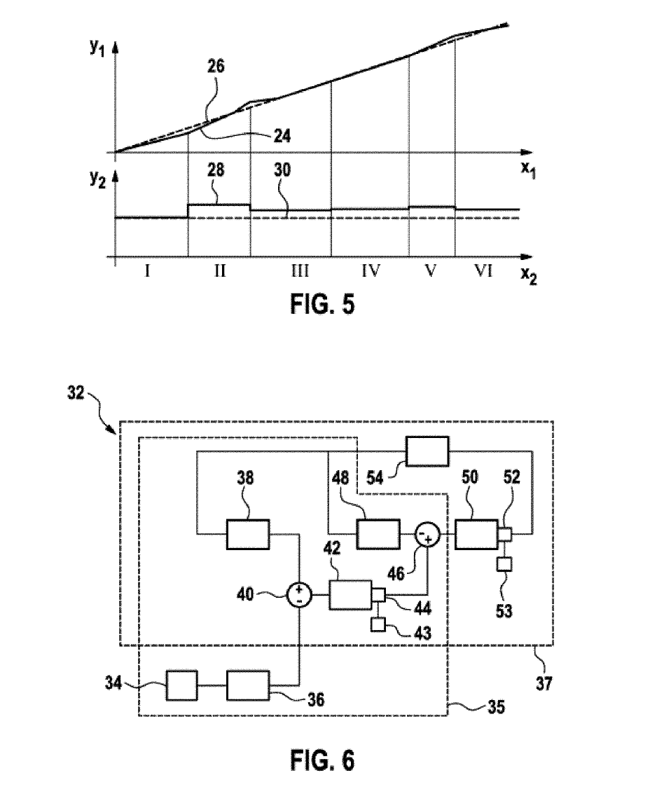

In this case, suitable control or regulation, for example, can result in the performance of the battery rising in a desired manner but the load on the battery, such as particularly the ageing thereof, not rising above a predefined value. This is shown in FIG. 5.

FIG. 5 schematically shows a plot of the life of the battery on the axis X₁ and a loading of the battery on the axis Y₁ in detail in the top graph. In the bottom graph, it schematically shows a plot of the life of the battery on the axis X₂ and a threshold value for an operating parameter, such as the voltage, for example, on the axis Y₂. In this case, the curve 24 shows a specifically occurring loading of the battery, the curve 26 shows a desired limit for the loading of the battery, the curve 28 shows a specifically available operating parameter, such as the voltage, and the line 30 shows a desired threshold value for the operating parameter, such as the normal operating threshold 16, for example. Furthermore, sections I to VI are intended to indicate various time intervals.

By comparing the top and bottom graphics, it is possible to show that appropriate regulation, that is to say raising or lowering of the magnitude of the operating parameter, such as the voltage, for example, allows a response to be given to different and possibly also unforeseen influences, and thus allows the load always to be kept within desired limits. As a result, the ageing of the battery can likewise be observed as desired for example. By way of example, at the beginning of section II, when the actual load is below the desired or permitted value, it is possible for the voltage to be raised. If the actual load is above a prescribed value, on the other hand, then the operating parameter can be lowered, as shown in section III, so that a predetermined load can always be observed in a simple manner.

A preferred but purely exemplary feedback control structure 32, in order to carry out regulation based on a load on the battery, for example, is further shown in FIG. 6. The feedback control structure 32 is particularly part of a feedback control unit of a battery system.

The feedback control structure 32 in FIG. 6 is particularly part of a battery system and may, in detail, be part of a control unit or feedback control unit, such as of the battery management system, for example. The feedback control structure 32 in accordance with FIG. 6 or the control unit or feedback control unit may in this case be connected to the battery via connections that are not shown, so as to be able to perform a regulatory action based on the controlled variables produced in the feedback control structure 32.

In detail, the feedback control structure 32 comprises a first control loop 35 and a second control loop 37, which is interleaved with the first control loop 35, as will become evident below. In this case, the first control loop 35 is designed to output at least one controlled variable for achieving a prescribed ageing profile, and the second control loop 37 is further designed to output at least one controlled variable for achieving a prescribed loading criterion. In detail, a setpoint value of the first control loop 35 is selectable and a setpoint value of the second control loop 37 is based on a controlled variable that is output by the first control loop 35.

The manner of operation of the feedback control structure 32 and the interleaving of the control loops 35, 37 are described below.

First of all, a setpoint value for a desired ageing state or ageing profile with reference to capacity (SOHc) is input into the feedback control structure 32 in an input unit 34, particularly as a single external input. Said setpoint value may correspond, by way of example, to a capacity of 80% within ten years or within a mileage of 300 000 km based on the original value, and can therefore relate to a desired value at a particular time in the future, for example, a linear drop being able to be assumed. Hence, the function block 36 contains the setpoint SOHc, which should be there at the present time based on a desired ageing profile. Said setpoint SOHc is routed to a function block 40, which is supplied with a currently existent SOHc in equal measure. The currently existent SOHc can be ascertained by the function block 38 and routed to the function block 40. The currently existent SOHc can be ascertained in a manner comprehensible to a person skilled in the art on the basis of measured voltage values during a charging cycle, by way of example.

A comparison of the setpoint SOHc with the currently existent SOHc allows a corresponding difference to be ascertained in the function block 40. This difference is routed to a transformation block 42, such as a PID controller, for example, which can output a controlled variable, in a manner that is known per se and implementable without any problems in control engineering, by defining a desired controlled section as output 44. As a controlled variable of this kind, it is possible to output a setpoint load for the battery, for example, so as to thereby adjust the ageing profile by adapting the load.

This setpoint load is in turn routed to a function block 46 in which the setpoint load is compared with a currently existent load. The currently existent load can be ascertained in the function block 48 and routed to the function block 46.

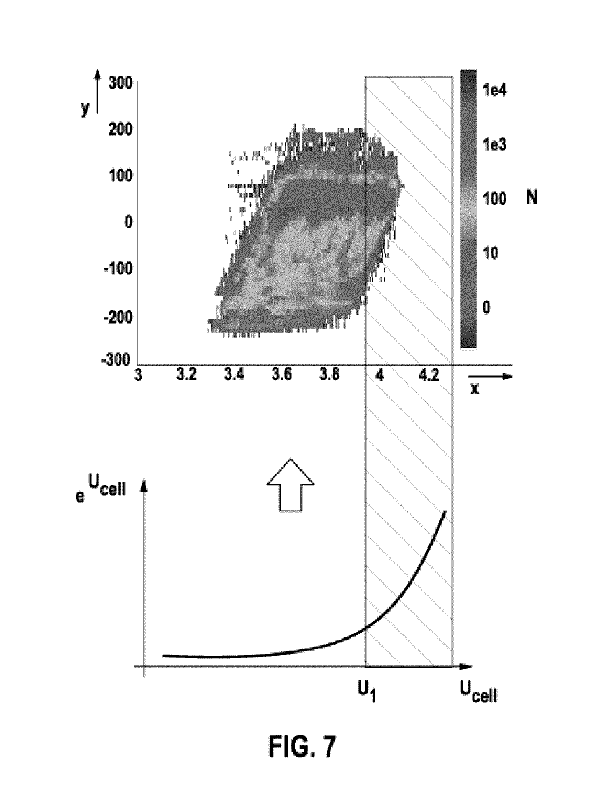

FIG. 7 shows an example of the ascertainment of a load criterion during operation of the battery. In detail, the top graph in FIG. 7 shows a two-dimensional histogram in which the voltage is indicated, particularly as an upper voltage limit, on the X axis and wherein the current flowing through the battery is indicated on the Y axis. The scale N further shows the number of occurrences of the applicable values. Such a history of the operating parameters can be provided during operation of the battery, for example. By way of example, this can be implemented during a driving period of approximately 10 hours for an electrically driven vehicle.

Alteration of the voltage value leads to a shift in the histogram, since the current is multiplied by the factor e^{(U-U(I))}.

In the bottom graph, the cell voltage U_{cell} is plotted against the factor e^{Ucell}. In this case, it is evident that a significant alteration occurs particularly at high voltages. It becomes particularly evident that including values that are above a limit value U_{I} may be sufficient, since values below this limit value may not bring about significant alterations.

Returning to the function block 46, the difference between the setpoint value and the currently existent value for the load is formed therein and routed to the transformation block 50, such as a PID controller, for example. The latter can optionally have additional limits supplied to it as upper and lower limits for the values to be regulated. The output 52 that is output therein is again a controlled variable that may be, for example, an operating parameter, such as particularly current, voltage or temperature, so as thereby to adapt the load to the setpoint value, as is possible in control engineering, in a manner that is known per se and implementable without any problems, by defining a desired controlled section. The controlled variable can be routed from the output 52 to a memory 54, for example. Regardless of the provision of the memory 54, the controlled variable can be routed to the function block 38, 48. As such, it is again possible for the currently existent SOHc to be ascertained in the function block 38 and for the currently existent load to be ascertained in the function block 48.

The operating principle is therefore based on adjusting a setpoint loading or setpoint load for the battery that allows a defined ageing process for the battery to be made possible. A prerequisite therefor is the definition of a suitable, measurable load value that accumulates over time and that, in accordance with this configuration, is based on the desired ageing profile.

The feedback control system above is used particularly for long-term control. There may further be provision for the outputs 44, 52 to be varied with reference to short-term control, and hence for the threshold values to be increased for a short time. To this end, further setpoint variables 43, 53 are processed.

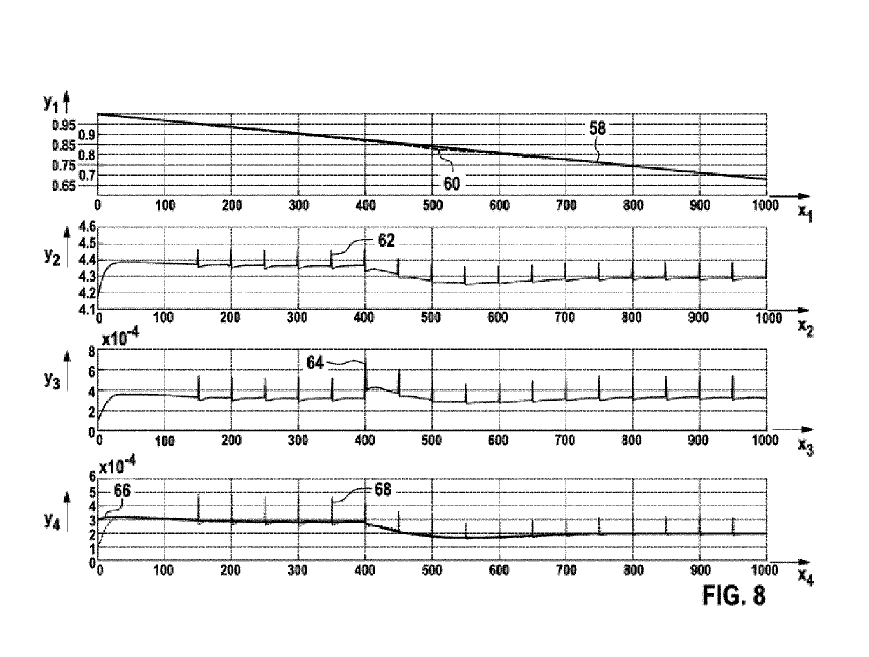

FIG. 8 shows an example of a feedback control system in accordance with the invention for a battery. The number of charging cycles is respectively plotted on the axes X₁, X₂, X₃ and X₄, whereas the SOHc is plotted on the axis Y₁, a voltage threshold in volts, which is based on the feedback control system in accordance with the invention, is indicated on the axis Y₂, and wherein the ageing or SOH loss per charging cycle is plotted on the axes Y₃ and Y₄.

In this case, in the top graph, the line 58 shows the setpoint value for the ageing and the curve 60 shows the ascertained value of the ageing. It can be seen in the top graph that an unforeseen increase in the ageing occurs at approximately 400 charging cycles.

In the second graph, the curve 62 reveals the voltage set by the feedback control system. What is shown is that the feedback controller locks onto a regulated cell voltage in the first few cycles as an upper limit. With reference to the second graph, particularly the height of the base line shows long-term control, whereas the peaks show short-term control.

The short-term control allows a higher voltage level, which may be increased by 100 mV by way of example, to be reached for a short time. Further, it can be seen that the set voltage is likewise decreased in the case of the loss of SOHc or in the case of the unforeseen ageing, by virtue of the voltage being reduced by approximately 70 mV by the feedback control system. As a result, the actual value of the SOHc aligns itself with the setpoint value again, as can be seen in the top graph.

In the third graph, the curve 64 shows the ageing, whereas in the fourth graph, the curve 66 shows the target load or the SOHc loss and the curve 68 shows the actually existent load or the actually existent SOHc loss. In this case, it is again possible to see the effectiveness of the feedback control system, since even in the event of an unforeseen change in the ageing, the ageing can become constant again by virtue of the load that acts on the battery being adapted, which means that the desired values of future ageing can be observed without any problems, since the SOHc loss corresponds to the target value.

1. A method for operating a battery system, wherein the battery system comprises a battery that is operable with an operating parameter, the method comprising:
a) operating the battery with a predefined magnitude of the operating parameter such that
b) selecting, based on a loading criterion, at least one from the period of operation of the battery with the predefined magnitude of the operating parameter and the magnitude of the operating parameter, wherein
c) ascertaining the loading criterion for the purpose of observing a future predetermined ageing profile of the battery, the ageing profile based on a loading of the battery by the operating parameter.

2. The method as claimed in claim 1, characterized in that the operating parameter is selected from the group consisting of voltage, current and temperature.

3. The method as claimed in claim 1, characterized in that the method is effected at least partly during a charging process of the battery.

4. The method as claimed in claim 1, characterized in that the loading criterion is ascertained during operation of the battery.

5. The method as claimed in claim 1, characterized in that the loading criterion is ascertained on the basis of a stored history of the operating parameter.

6. The method as claimed in claim 1, characterized in that the loading criterion is ascertained by exclusively considering values that are above a predefined threshold.

7. The method as claimed in claim 1, characterized in that the predefined magnitude of the operating parameter is selected on the basis of a control period.

8. The method as claimed in claim 1, characterized in that the method is performed using at least two operating parameters.

9. A battery system, having at least one battery and a feedback control unit for regulating the battery, characterized in that the feedback control unit is configured to carry out a method as claimed in claim 1.

10. The battery system as claimed in claim 9, characterized in that the feedback control unit has at least one first control loop (35) and a second control loop (37), which is interleaved with the first control loop (35).

11. The battery system as claimed in claim 10, characterized in that the first control loop (37) is designed to output at least one controlled variable for the purpose of achieving a prescribed ageing profile and in that the second control loop (37) is designed to output at least one controlled variable for the purpose of achieving a prescribed loading criterion.

12. The battery system as claimed in claim 11, characterized in that a setpoint value of the first control loop (35) is selectable.

13. The battery system as claimed in claim 11, characterized in that a setpoint value of the second control loop (37) is based on a controlled variable output by the first control loop (35).

14. The battery system as claimed in claim 10, characterized in that the battery system is arranged in an electrically drivable vehicle.
